(19) United States
(12) Patent Application Publication
(10) Pub. No.: US 2003/0200314 A1
(43) Pub. Date: Oct. 23, 2003

(54) Remote access to aggregated grouping of distributed content

(75) Inventor: Michael J. Giffin, Tustin, CA (US)

Correspondence Address: GATEWAY, INC., 14303 GATEWAY PLACE, ATTENTION: MARK WALKER (MAIL DROP SD-21), POWAY, CA, 92064, US

(73) Assignee: Gateway, Inc.

(21) Appl. No.: 10/126,905

(22) Filed: Apr. 19, 2002

(51) Int. Cl. G06F 15/16; G06F 15/173

(52) U.S. Cl. 709/225; 709/231

(57) ABSTRACT

A method, apparatus, and signal-bearing medium that may create and aggregate service elements that describe media content in a network. The service elements may be used to access the media content from a variety of clients in the network, regardless of where the service elements were created.

### CROSS REFERENCE TO RELATED APPLICATIONS

This application is related to application Ser. No. __/___,___ filed, 2002, entitled “Cataloging Digital Radio Stations” (attorney docket 450.350US1) and to application Ser. No. __/___,___ filed, 2002, entitled “Cataloging Audio Content” (attorney docket 450.349US1).

### FIELD

This invention relates generally to a network of electronic devices and more particularly to aggregating distributed content in a network of electronic devices.

### BACKGROUND

Years ago, people listened to music on radios and watched movies in theaters. But today, audio and video have become increasingly more digital with people listening to and viewing a wide variety of media content, such as compact discs (CDs) in players attached to computers, radio stations over the Internet, and digital music files and videos stored on computers. Further, networks now distribute this media content to a variety of playback devices attached to the network.

Because such a large amount of media content is available, users experience difficulty in finding and accessing it in a network. This problem is exacerbated because users may wish to access the same media content from a variety of network devices, e.g., they may wish to find and play the same song on a boombox in the kitchen and a stereo system in the den. Thus, there is a need for a solution that will help users manage media content across multiple networked devices.

### SUMMARY

A method, apparatus, and signal-bearing medium is provided that creates and aggregates service elements that describe media content in a network. The service elements may be used to access the media content from a variety of clients in the network, regardless of where the service elements were created.

### BRIEF DESCRIPTION OF THE DRAWINGS

FIG. 1 depicts a block diagram of a system for implementing an embodiment of the invention.

FIG. 2 depicts a pictorial representation of an example user interface, according to an embodiment of the invention.

FIG. 3 depicts a pictorial representation of an example data structure, according to an embodiment of the invention.

FIG. 4 depicts a flowchart of example processing, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

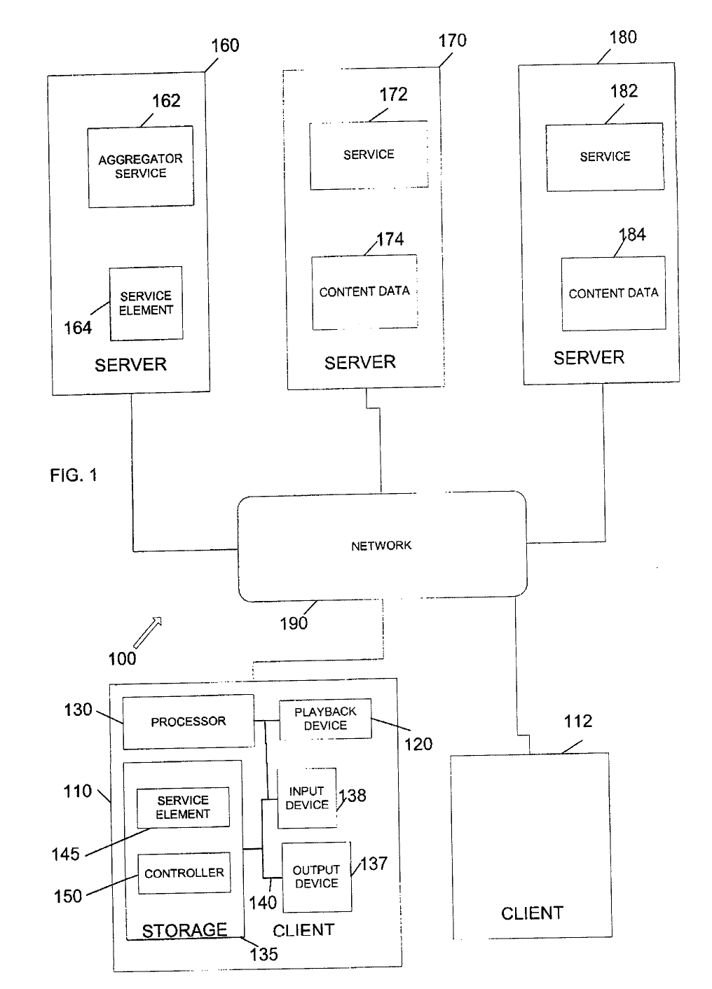

FIG. 1 depicts a block diagram of a system 100 for implementing an embodiment of the invention. The system 100 may include clients 110 and 112 connected to servers 160, 170, and 180 via a network 190. Although two clients 110 and 112 are shown, in other embodiments any number of clients may be present. Although three servers 160, 170, and 180 are shown, in other embodiments any number of servers may be present.

The client 110 may include a playback device 120, a processor 130, a storage device 135, an output device 137, and an input device 138, all connected via a bus 140.

The playback device 120 may be a speaker, stereo system, boombox, television, VCR (Video Cassette Recorder) or any other device capable of playing audio or video. Although only one playback device 120 is shown in the client 110, in another embodiment multiple playback devices may be present of the same type or different types. Although the playback device 120 is shown to be contained within the client 110, in another embodiment the playback device 120 may be external to the client 110.

The processor 130 may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 130 may execute instructions and may include that portion of the client 110 that controls the operation of the entire client. Although not depicted in FIG. 1, the processor 130 typically includes a control unit that organizes data and program storage in memory and transfers data and other information between the various parts of the client 110. The processor 130 may receive input data from the input device 138 and via the network 190, may read and store code and data in the storage device 135, may send audio and/or video signals to the playback device 120, and may present data to the output device 137.

Although the client 110 is shown to contain only a single processor 130 and a single bus 140, the present invention applies equally to clients that may have multiple processors and to clients that may have multiple buses with some or all performing different functions in different ways.

The storage device 135 represents one or more mechanisms for storing data. For example, the storage device 135 may include read only memory (ROM), random access memory (RAM), magnetic disk storage media, optical storage media, flash memory devices, and/or other machine-readable media. In other embodiments, any appropriate type of storage device may be used. Although only one storage device 135 is shown, multiple storage devices and multiple types of storage devices may be present. Further, although the client 110 is drawn to contain the storage device 135, it may be distributed across other clients or servers.

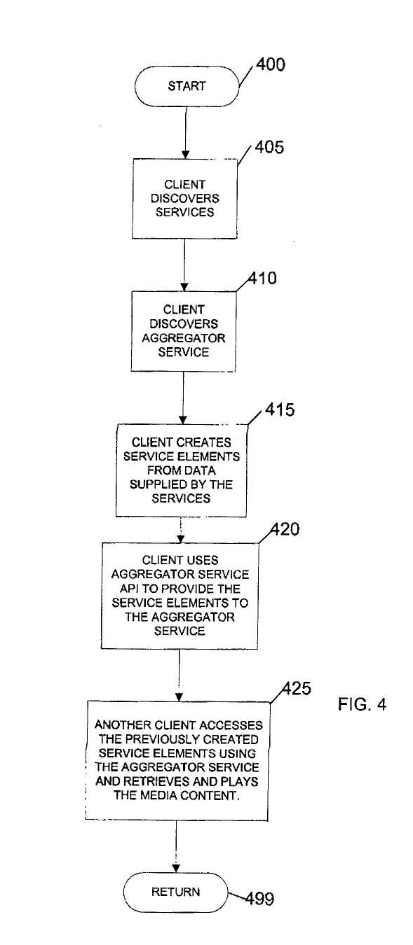

The storage device 135 may include a service element 145 and a controller 150. The controller may include instructions capable of being executed on the processor 130 to carry out the functions of the present invention, as further described below with reference to FIG. 4. In another embodiment, some or all of the functions of the present invention may be carried out via hardware in lieu of a processor-based system. Of course, the storage device 135 may also contain additional software and data (not shown), which is not necessary to understanding the invention.

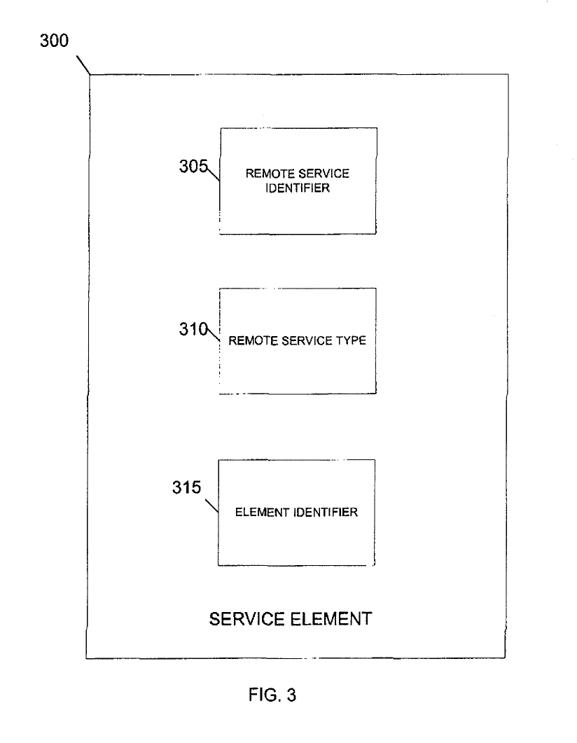

The service element 145 may contain information describing how to access media content data at remote locations. The service element 145 is further described below with reference to FIG. 3.

The output device 137 may display output to the user. The output device 137 may be a cathode-ray tube (CRT) based video display well known in the art of computer hardware. But, in other embodiments the output device 137 may be replaced with a liquid crystal display (LCD) based or gas, plasma-based, flat-panel display. In still other embodiments, any appropriate display device may be used. Although only one output device 137 is shown, in other embodiments, any number of output devices of different types or of the same type may be present. In another embodiment, the output device 137 may not be present.

The input device 138 may be a keyboard, mouse, trackball, touchpad, touchscreen, keypad, voice recognition device or any other appropriate mechanism for the user to input data to the client 110. Although only one input device 138 is shown, in another embodiment any number of input devices may be present. Although the input device 138 is shown as being part of the client 110, in another embodiment it may be packaged separately.

The bus 140 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller).

The client 110 may be implemented using any suitable hardware and/or software, such as a personal computer or other electronic computing device. Portable computers, laptop or notebook computers, PDAs (Personal Digital Assistants), two-way alphanumeric pagers, keypads, portable telephones, pocket computers, and mainframe computers are examples of other possible configurations of the client 110. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports accessing content in a network. The client 112 may be analogous to the client 110, and may include more or fewer elements than the client 110, and may be of the same or a different type as the client 110.

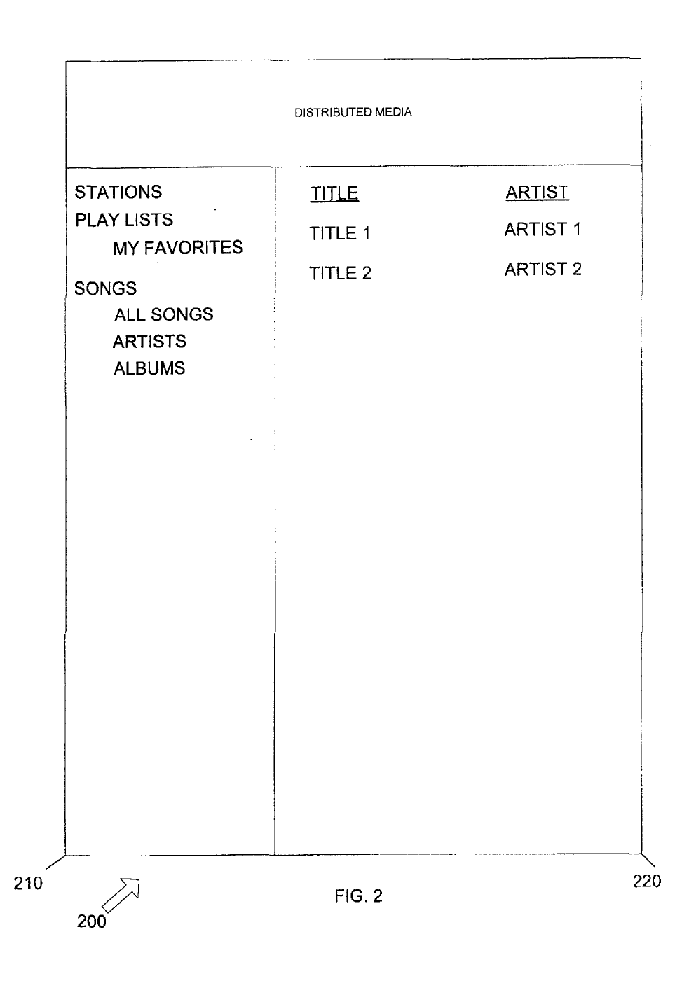

The server 160 may be implemented by a computer or other electronic device, analogous to the hardware and software already described for the client 110. The server 160 may include an aggregator service 162 and service elements 164. The aggregator service 162 may aggregate information about remote media content, as further described below with reference to FIGS. 2, 3, and 4. In an embodiment, the aggregator service 162 may include instructions capable of being executed on a processor. In another embodiment, the aggregator service 162 may be implemented in hardware in lieu of a processor-based system.

The aggregator service 162 may support a set of methods that manage references to the service elements 164, an example API (Application Program Interface) for which is illustrated below:

GroupID CreateGroupo

Void appendElement(GroupID, ServiceElement)

Void appendElements(GroupID, ServiceElement[])

Void insertElement(GroupID, Index, ServiceElement)

Void insertElements(GrouplD, Index, ServiceElement[])

Void removeElement(GroupID, Index)

Void removeElements(GroupID, Index, count)

Void moveElement(GroupID, FromIndex, Tolndex)

ServiceElement getElement(GroupID, Index)

ServiceElement[] getElements(GroupID, Index, count)

The GroupID in this API refers to a unique group provided by the aggregator service 162 and is passed to all methods to identify which group is being operated on. Since this GroupID itself constitutes an Element ID, inserting or appending references to these groups can achieve a hierarchical organization. Thus, the controller 150 may invoke methods in the API (such as appendElement, appendElements, insertElement, and/or insertElements) of the aggregator service 162 to add the service elements 145 to a group identified by the GroupID. Further, the client 112 may invoke methods (such as getElement and/or getElements) in the API of the aggregator service 162 to retrieve elements from the group identified by the GroupID. In this way, the client 112 may access service elements created by the client 110.

The service element 164 may contain information about aggregated remote media content, as further described below with reference to FIGS. 3 and 4.

The servers 170 and 180 may be implemented by a computer or other electronic device, analogous to the hardware and software already described for the client 110. The server 170 may include a service 172 and content data 174. The service 172 may provide information about the content data 174 and deliver the content data 174 to the clients 110 and/or 112. In an embodiment, the service 172 includes instructions capable of being executed on a processor. In another embodiment, the service 172 may be implemented in hardware in lieu of a processor-based system. The content data 174 may contain audio and/or video media content.

The server 180 may include a service 182 and content data 184. The server 180 may be analogous to the server 170. The service 182 and the content data 184 may be analogous to the service 172 and the content data 174, respectively.

The network 190 may be any suitable network and may support any appropriate protocol suitable for communication between the servers 160, 170, and 180 and the clients 110 and 112. In an embodiment, the network 190 may support wireless communications. In an embodiment, the network 190 may support hard-wired communications, such as a telephone line or cable. In an embodiment, the network 190 may support HPnP (Home Plug and Play). In an embodiment, the network 190 may support HAVi (Home Audio-Video interoperability) In another embodiment, the network 190 may support the Ethernet IEEE (Institute of Electrical and Electronics Engineers) 802.3x specification. In another embodiment, the network 190 may support the Ethernet Gigabit IEEE 802.3z specification. In another embodiment, the network 190 may be the Internet and may support IP (Internet Protocol). In another embodiment, the network 190 may be a local area network (LAN) or a wide area network (WAN). In another embodiment, the network 190 may be a hotspot service provider network. In another embodiment, the network 190 may be an intranet. In another embodiment, the network 190 may be a GPRS (General Packet Radio Service) network. In another embodiment, the network 190 may be any appropriate cellular data network or cell-based radio network technology. In another embodiment, the network 190 may be a version of the IEEE 802.11 wireless network. In another embodiment the network 190 may be a storage area network. In still another embodiment, the network 190 may be any suitable network or combination of networks. Although one network 190 is shown, in other embodiments any number of networks (of the same or different types) may be present.

As will be described in detail below, aspects of an embodiment pertain to specific apparatus and method elements implementable on an electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium, e.g., a read-only memory device attached to or within an electronic device, such as a CD-ROM readable by a CD-ROM drive;

(2) alterable information stored on a rewriteable storage medium, e.g., a hard disk drive or diskette; or

(3) information conveyed to an electronic device by a communications medium, such as through a computer or a telephone network, including wireless communications.

Such signal-bearing media, when carrying machine-readable instructions that direct the functions of the present invention, represent embodiments of the present invention.

FIG. 2 depicts a pictorial representation of an example user interface 200, which may be displayed on the output device 137, according to an embodiment of the invention. The user interface 200 may include a navigation frame 210 and a content frame 220, which is displayed as a result of the user selecting an item in the navigation frame. The user interface 200 may display an aggregated view of available distributed media content, which may reside at multiple sources. For example, the songs identified in the content frame 220 may reside at different servers, for example in content data 174 and content data 184. The controller 150 aggregates the distributed media content displayed in the user interface 200 as further described below with reference to FIGS. 3 and 4.

FIG. 3 depicts a pictorial representation of an example service element data structure 300, which the controller 150 may use to aggregate media content from multiple sources according to an embodiment of the invention. The service element 300 may represent the service element 145 and/or the service element 164, as shown in FIG. 1. Referring again to FIG. 3, the service element 300 may include a remote service identifier 305, a remote service type 310, and an element identifier 315. The remote service identifier 305 may be a unique key that identifies a remote service (e.g. the service 172 or the service 182 in the example of FIG. 1). The remote service type 310 may be a unique key that identifies the type of the remote service specified by the remote service identifier 305. The element identifier 315 may identify the content data (e.g. the content data 174 or 184 in the example of FIG. 1), which may be accessed via the service identified by the remote service identifier 305.

The service element 300 allows the controller 150 to uniquely identify and retrieve a particular content item (e.g. content data 174 or content data 184) from any remote server attached to the network 190. The controller 150 uses the remote service identifier 305 to locate and identify the exact remote server (170 or 180) containing the desired content item (174 or 184) and allows the controller 150 to make remote method calls to the appropriate remote service (172 or 182) using the underlying protocol that the remote service (172 or 182) is implemented in. The controller 150 uses the remote service type 310 to identify the set of methods available from the remote service (172 or 182) making it possible to infer the correct method to use to retrieve the content data (174 or 184) from the remote service (172 or 182). The controller 150 may typically pass the element identifier 315 as a parameter to the appropriate content retrieval method previously identified.

FIG. 4 depicts a flowchart of example processing, according to an embodiment of the invention. Control begins at block 400. Control then continues to block 405 where the controller 150 discovers the services 172 and 182. In an embodiment, the controller 150 discovers the services 172 and 182 using a discovery protocol, although in other embodiments any appropriate discovery technique may be used.

Control then continues to block 410 where the controller 150 discovers the aggregator service 162 using a discovery protocol, although in other embodiments any appropriate discovery technique may be used.

Control then continues to block 415 where the controller 150 creates service elements 145 from data supplied by the services 172 and 182. Control then continues to block 420 where the controller 150 uses the API for the aggregator service 162 to provide the service elements 145 to the aggregator service 162, which stores the service elements 145 as service elements 164.

Control then continues to block 425 where the client 112 discovers the aggregator service 162 and accesses the service elements 164. The client 112 then uses the service elements 164 to display a user interface, such as user interface 200, which describes the aggregated data describing both content data 174 and content data 184. The client 112 then uses the service elements 164 and services provided by the service 172 and/or the service 182 to play the content data 174 and/or the content data 184 on a playback device associated with the client 112. Control then continues to block 499 where the function returns.

In this way, remote access over a network is provided to aggregated groupings of content data, so that a grouping can be created from one client and then accessed by another client.

What is claimed is:

1. A method, comprising:
discovering a plurality of remote services in a network;
creating a plurality of service elements that describe the respective plurality of remote services; and
providing the plurality of service elements to an aggregator service.

2. The method of claim 1, wherein the creating the plurality of service elements further comprises:
creating a plurality of remote service identifiers that identify the respective plurality of remote services.

3. The method of claim 1, wherein the creating the plurality of service elements further comprises:
creating a plurality of remote service types associated with the respective plurality of remote services.

4. The method of claim 1, wherein the creating the plurality of service elements further comprises:
creating a plurality of element identifiers t hat identify media content associated with the respective plurality of remote services.

5. The method of claim 1, wherein the providing the plurality of service elements to the aggregator service further comprises:
invoking a method provided by the aggregator service to add the plurality of service elements to a group.

6. The method of claim 1 further comprising:
retrieving the plurality of service elements from the aggregator service.

7. A signal-bearing medium encoded with instructions that when executed on a processor comprise:
retrieving an aggregated group of service elements from an aggregator service;
finding content data associated with the group of service elements; and
displaying the content data.

8. The signal-bearing medium of claim 7, wherein the retrieving further comprises:
invoking a remote method in the aggregator service to retrieve the service elements.

9. The signal-bearing medium of claim 7, wherein the finding the content data further comprises:
retrieving a remote service identifier from one of the service elements; and
invoking a remote service identified by the remote service identifier.

10. The signal-bearing medium of claim 9, wherein the finding the content data further comprises:
retrieving an element identifier from one of the service elements; and
passing the element identifier to the remote service identified by the remote service identifier.

11. The signal-bearing medium of claim 7, wherein the finding the content data further comprises:
invoking a remote method identified by a remote service identifier and a remote service type in one of the service elements.

12. A signal-bearing medium encoded with a data structure to be accessed by a controller that executes on a processor, wherein the data structure comprises:
a remote service identifier that identifies a remote service;
a remote service type that describes the remote service; and
an element identifier that identifies remote content associated with the remote service, wherein the controller is to create the data structure from information retrieved from the remote service.

13. The signal-bearing medium of claim 12, wherein the controller is to invoke a method provided by an aggregator service to add the data structure to a group at a server.

14. The signal-bearing medium of claim 13, wherein a second controller is to retrieve the remote content using the aggregator service and the remote service.

15. The signal-bearing medium of claim 14, wherein the second controller is to play the remote content at a playback device.

16. A system comprising:
a first server comprising an aggregator service; and
a client to discover a remote service and media content associated with the remote service, create a service element that identifies the service and the media content, and provide the service element to the aggregator service.

17. The system of claim 16, wherein the client is further to invoke a method of the aggregator service to add the service element to a group.

18. The system of claim 16, wherein the client is further to add a type of the remote service to the service element.

19. The system of claim 17, further comprising:
a second client to invoke a method of the aggregator service to retrieve the service element from the group.

20. The system of claim 19, wherein the second client is further to use the service element to access the remote service and invoke a method of the remote service to retrieve the media content.
